(19) United States
(12) Patent Application Publication
(10) Pub. No.: US 2026/0267295 A1
(43) Pub. Date: Sep. 10, 2026

(54) METHOD FOR OPERATING A SENSOR SYSTEM AND SENSOR SYSTEM

(71) Applicant: Beckhoff Automation GmbH, Verl (DE)

(72) Inventors: Patrick Jebramcik, Gütersloh (DE); Christopher Pohl, Verl (DE)

(21) Appl. No.: 19/664,260

(22) Filed: Apr. 30, 2026

Related U.S. Application Data
(63) Continuation of application No. PCT/EP2025/078959, filed on Oct. 8, 2025.

(30) Foreign Application Priority Data
Nov. 11, 2024 (DE) 102024132904.1

(51) Int. Cl. G05B 11/01; G01D 9/02

(52) U.S. Cl. CPC G05B 11/012; G01D 9/02

(57) ABSTRACT

This application relates to a method for operating a sensor system having at least one controller and a sensor unit. The method includes receiving a trigger message sent by the controller via the two-wire physics with the aid of the sensor unit, processing the trigger message via the second microcontroller unit of the sensor unit, and transmitting the response message from the sensor unit to the controller at a transmission time via the sensor unit. The application also relates to a sensor system.

### CROSS-REFERENCE TO RELATED APPLICATIONS

This application is a continuation of International patent application PCT/EP2025/078959, filed Oct. 8, 2025, which claims the priority of German patent application 10 2024 132 904.1, filed Nov. 11, 2024, the contents of each of which are incorporated herein by reference in the entirety and for all purposes.

### FIELD

The application relates to a method for operating a sensor system. The application further relates to a sensor system.

### BACKGROUND

Sensor systems with controllers and sensor units are known from the prior art. Reliable data communication between the controller and the sensor unit is necessary for exact and precise control of the sensor unit by the controller. Furthermore, it must be possible to ensure that the recording of sensor values by the sensor unit may be controlled by the controller.

### SUMMARY

The application provides an improved method for operating a sensor system and an improved sensor system.

According to an aspect, a method for operating a sensor system with at least one controller and one sensor unit is provided, wherein the controller and the sensor unit are connected to each other via a two-wire physics, wherein data communication between the controller and the sensor unit is realized via the two-wire physics, wherein the controller comprises a first microcontroller unit and the sensor unit comprises a second microcontroller unit for carrying out the data communication, wherein the method comprises:
receiving a trigger message sent by the controller via the two-wire physics by the sensor unit in a receiving step;
determining a receipt time of the receipt of the trigger message by the second microcontroller unit of the sensor unit in a receipt time determining step;
determining a transmission time for transmitting a response message from the sensor unit to the controller based on the receipt time by the second microcontroller unit of the sensor unit in a transmission time determining step, wherein the transmission time is later than the receipt time by a first predefined delay period;
processing the trigger message via the second microcontroller unit of the sensor unit in a processing step;
generating the response message via the second microcontroller unit of the sensor unit in a message generating step;
transmitting the response message from the sensor unit to the controller at a transmission time by the sensor unit in a transmitting step.

This may achieve the technical advantage of allowing for an improved method for operating a sensor system. In particular, the method according to the application allows for data communication between a controller and a sensor unit of the sensor system.

### BRIEF DESCRIPTION OF THE DRAWINGS

The application is described in more detail with reference to the accompanying figures, which show:

FIG. 1 is a schematic depiction of a sensor system according to an embodiment;

FIG. 2 is a schematic depiction of data communication between a controller and a sensor unit of the sensor system according to an embodiment;

FIG. 3 is a flowchart of a method for operating a sensor system according to an embodiment;

FIG. 4 is a further flowchart of the method for operating a sensor system according to a further embodiment;

FIG. 5 is a further flowchart of the method for operating a sensor system according to a further embodiment;

FIG. 6 is a further flowchart of the method for operating a sensor system according to a further embodiment; and

FIG. 7 is a further flowchart of the method for operating a sensor system according to a further embodiment.

In the following, the same reference numerals may be used for elements with the same function. As the case may be, these elements may not be described again for each figure. Nevertheless, said elements with the same function may be provided accordingly in all embodiments.

### DETAILED DESCRIPTION

As described herein, data communication can take place entirely on the basis of a two-wire physics with two current-carrying transmission wires.

In order to carry out the data communication, the controller comprises a first microcontroller unit and the sensor unit comprises a second microcontroller unit. According to the application, the data communication is carried out exclusively by the first and second microcontroller units.

The use of technically complex and therefore expensive calculation components, such as FPGAs, which are used in state-of-the-art technology for data communication based on two-wire physics, may be avoided.

The use of two-wire physics for data communication makes it possible to save on additional transmission wires.

The use of microcontrollers in order to generate and/or read out the trigger messages and response messages to be exchanged or exchanged between the controller and the sensor unit represents a technically simple and therefore cost-effective implementation of data communication via two-wire physics.

According to the application, for data communication, a trigger message sent by the controller is received by the sensor unit at a receipt time.

Based on the receipt time, the second microcontroller unit of the sensor unit determines a transmission time at which a response message to the trigger message from the controller is to be transmitted from the sensor unit to the controller via the two-wire physics.

The transmission time is determined by the second microcontroller unit of the sensor unit based on the receipt time in such a way that the transmission time is a first predefined delay period later than the receipt time.

The response message is therefore not sent from the sensor unit to the controller at any arbitrary time. Instead, the response message is sent after the first predefined delay period following receipt of the trigger message.

The first predefined delay period is applied by the second microcontroller unit of the sensor unit to each trigger message received from the controller.

Each response message from the sensor unit may thus be sent after the same first predefined delay period following receipt of the respective trigger message.

This allows for a determined data communication between the controller and the sensor unit, in which each response message from the sensor unit is sent after the same first predefined delay period following the time of receipt of the respective trigger message from the controller.

Furthermore, it is not necessary for data communication that the sensor unit and, in particular, the second microcontroller unit of the sensor unit knows when a trigger message is sent by the controller.

By determining the respective receipt time upon receipt of the response message and calculating the corresponding transmission time, the second microcontroller unit of the sensor unit allows for the sensor unit to transmit a corresponding response message to each trigger message transmitted by the controller at any time.

By calculating the transmission time for sending the response message, taking into account the determined receipt time and the first predefined delay period installed or stored in the second microcontroller unit of the sensor unit, the transmission of the response message may be carried out in a determined manner. The transmission time is always later than the receipt time by the first predefined delay period.

If the controller knows the first predefined delay period between the receipt of the trigger message and the transmission of the response message by the sensor unit, and if it also knows the signal propagation time required for the trigger message or the response message to bridge the distance between the controller and the sensor unit via the two-wire physics, the controller may calculate the time at which the respective response message from the sensor unit will arrive at the controller when the trigger message is transmitted.

This allows for precisely operating the sensor system, in which the information provided by the sensor unit in the respective response messages may be taken into account in a time-synchronized manner.

By taking into account the first predefined delay period, precise time synchronization between the trigger messages from the controller and the response messages from the sensor unit may be achieved.

For the purposes of the application, the receipt time defines a timestamp that locates the receipt of the trigger message by the sensor unit in time. Accordingly, the transmission time defines a timestamp that locates the transmission of the response message by the sensor unit in time.

### EXAMPLES

According to an embodiment, the receipt time determining step comprises:
determining a first temporal positioning of the trigger message in an input buffer of the serial communication interface via the second microcontroller unit in a first positioning determining step; wherein the first temporal positioning in the input buffer corresponds to the receipt time of the trigger message; wherein the transmission time determining step comprises:
determining a second temporal positioning of the response message in an output buffer of a serial communication interface unit of the second microcontroller unit via the second microcontroller unit in a second positioning determining step, wherein the second temporal positioning is temporally spaced from the first temporal positioning by a second predefined delay time period, and wherein the transmission time is determined based on the second positioning of the response message in the output buffer of the serial communication interface unit.

This may achieve the technical advantage of allowing for a technically simple determination of the transmission time based on the receipt time. In order to carry out data communication, the second microcontroller unit of the sensor unit comprises a serial communication interface unit.

As is known from the prior art, the serial communication interface unit comprises an input buffer and an output buffer. Upon receipt of the trigger message by the serial communication interface unit, the trigger message is arranged by the serial communication interface unit in the input buffer.

As is known from the prior art, the input buffer is processed over time so that each characteristic of the trigger message is placed in the input buffer in a corresponding temporal position.

As is also known from the prior art, in serial communication interfaces the information or data to be transmitted is first placed in an output buffer. The output buffer is then processed in chronological order and the data stored in the output buffer is transmitted in the order in which the output buffer is processed.

In order to ensure that the response message is transmitted at the time of receipt after the trigger message has been received by the first predefined delay period, the correspondingly generated response message is arranged in the output buffer in a second temporal position.

The second positioning is temporally distanced from the first positioning of the trigger message in the input buffer by a second predefined time period.

The second predefined delay period may be used as part of the first predefined delay period to generate the first predefined delay period.

The second predefined delay period is also predefined and stored in the second microcontroller unit of the sensor unit.

Based on the second predefined delay period, the transmission time for sending the response message is determined accordingly.

According to an embodiment, the receiving step comprises:
writing the received trigger message to the input buffer of the serial communication interface unit of the second microcontroller unit by the second microcontroller unit in a first writing step; and wherein the message generating step comprises:
writing the response message to the output buffer of the serial communication interface unit to the second positioning determining step by the second microcontroller unit in a second writing step.

This may achieve the technical advantage of ensuring technically clean processing of the trigger message and corresponding generation of the response message.

According to an embodiment, the first writing step, the second writing step, and the processing step are carried out by the second microcontroller unit in execution cycles, wherein the second predefined delay period comprises a predefined number of execution cycles.

This may achieve the technical advantage of ensuring reliable processing of the trigger message and corresponding generation of a respective response message.

The trigger message is received by the serial communication interface unit of the second microcontroller unit of the sensor unit and written to the input buffer as described above.

Subsequently, the trigger message data written to the input buffer is processed by the CPU element of the second microcontroller unit of the sensor unit and a corresponding response message is generated.

The response message generated in this way is then written to the output buffer of the serial communication interface unit.

In the described embodiment, the trigger message is received in an n-th execution cycle and written to the input buffer; in an (n+x)-th execution cycle, the trigger message is processed by the CPU element and a corresponding response message is generated. In an (n+x+y)-th execution cycle, the correspondingly generated response message is written to the output buffer. The nth, (n+x)-th, and (n+x+y)-th execution cycles represent arbitrary execution cycles that are executed sequentially in time.

By generating the response message through the processing of the trigger message by the CPU element in one execution cycle and writing it to the output buffer in a later execution cycle, it is possible to ensure that the second predefined delay period may be guaranteed as an unchangeable period of time for each processing step of the CPU element.

It is therefore not necessary for the CPU element to start and complete the processing of the trigger message and the corresponding generation of the response message at the same time in each execution cycle in order to ensure that the second predefined time period is always the same.

By writing the data provided by the CPU element in one execution cycle to the output buffer in a later execution cycle, the second predefined delay period between the characteristics of the trigger message in the input buffer and the characteristics of the response message in the output buffer remains unchanged for each trigger message and response message, even if the data provided by the CPU element in the individual execution cycles is provided by the CPU element at different times.

A hard definition of the execution of the CPU element in the processing steps is therefore not necessary.

According to an embodiment, the method further comprises:
activating a timer unit of the sensor unit at an activation time to trigger the transmission of the response message at the transmission time by the second microcontroller unit of the sensor unit in an activating step, and
wherein the activation time is spaced apart in time by a third predefined delay period from the transmission time.

This may achieve the technical advantage that the timer precisely determines the transmission time of the response message in such a way that the transmission time distanced from the receipt time by the first predefined delay period.

A third predefined delay period is stored in the timer unit for this purpose. The third predefined delay period describes a period of time between an activation time at which the timer unit is activated and the transmission time at which the response messages are transmitted.

When the timer unit is activated at the activation time, the timer unit triggers the transmission of the response message at the transmission time after the third predefined delay period has elapsed.

The timer unit thus allows for sending the response message precisely at the transmission time.

According to an embodiment, the timer unit is further activated in the activating step at the activation time to trigger a sensor element of the sensor unit to measure sensor data at a measurement time, wherein the activation time is distanced from the measurement time by a fourth predefined delay period.

This may achieve the technical advantage that activating the timer unit may also trigger the recording of sensor data from a sensor element of the sensor unit.

The timer unit is set up in such a way that, after activation of the timer unit at the activation time, the timer unit triggers the recording of sensor data by the sensor element at a measurement time, wherein the measurement time is distanced from the activation time by a fourth predefined delay period.

The fourth predefined delay period means that the measurement time is fixed in relation to the activation time of the timer unit.

This allows the measurement time to be fixed deterministically with the receipt time of the trigger message, allowing to synchronize the receipt of the trigger message via the sensor unit and the recording of the sensor data via the sensor element.

According to an embodiment, a data output channel of the serial communication interface unit is connected to an input port of the timer unit, wherein the timer unit is activated by the response message applied by the output buffer to the data output channel of the serial communication interface unit.

This may achieve the technical advantage of allowing for technically simple activation of the timer unit.

This connects an input channel of the timer unit to a data output channel of the serial communication interface unit.

In order to transmit the generated response message, the data of the generated response message stored in the output buffer is placed on the data output channel. The data output channel corresponds to a MOSI channel of the serial communication interface unit.

In the described embodiment, the data of the response message is not transmitted directly via the two-wire physics from the data output channel. Instead, the data of the response message is first used by the data output channel as input signals for the timer unit.

If, after the response message has been generated by the CPU element of the second microcontroller unit, the response message stored in the output buffer of the serial communication interface unit can be transmitted, the corresponding data is placed on the data output channel. This automatically activates the timer unit.

This eliminates the need for additionally activating the timer unit to trigger the transmission of the response messages or to trigger data acquisition by the sensor element.

Since the timer unit is automatically activated by the response message placed on the data output channel, the activation of the timer unit is permanently linked to the generation of the response message by the CPU element or the serial communication interface unit.

This in turn allows to activate the timer unit and the associated transmission of the response message or to acquire sensor data to be synchronized with the receipt of the trigger message.

This in turn allows to transmit the response message or to record sensor data to be synchronized with the receipt of the trigger message.

According to an embodiment, the activation time is spaced apart by a fifth predefined delay period from the second temporal positioning of the response message in the output buffer.

This may achieve the technical advantage that the activation of the timer unit may be precisely synchronized with the receipt of the trigger message at the time of receipt.

For this purpose, the activation time is distanced from the second temporal positioning of the generated response message in the output buffer of the serial communication interface unit by a fifth predefined delay period.

By equating the first temporal positioning of the trigger message in the input buffer of the serial communication interface unit with the time of receipt of the trigger message, and by distancing the second positioning of the response message in the output buffer of the serial communication interface unit from the first temporal positioning by the second predefined delay period, the activation time is thus distanced from the receipt time by a sum of the second predefined delay period and the fifth predefined delay period.

The activation of the timer unit at the activation time is thus fixed in time with the receipt of the trigger message.

By distancing the transmission time from the activation time by the third predefined delay period, the transmission of the response message is thus fixed in time with the receipt of the trigger message.

By distancing the measurement time of the data acquisition from the activation time by the sixth predefined delay period, the data acquisition by the sensor element is also fixed in time to the receipt of the trigger message.

As all predefined delay periods are preinstalled in the second microcontroller unit of the sensor unit and cannot be changed during operation of the sensor system, the transmission of the response messages and the data acquisition by the sensor element are synchronized in time with the receipt of the trigger message.

According to an embodiment, the measurement time is distanced from the receipt time by a sixth predefined delay period.

This may achieve the technical advantage that the measurement time is fixed in relation to the receipt time. This allows for recording sensor data via the sensor element to be synchronized in time with the receipt of the trigger message.

According to an embodiment, the first predefined delay period between the receipt time and the transmission time is defined as the sum of the second predefined delay period between the first positioning of the first characteristic in the input buffer and the second positioning of the second characteristic in the output buffer and the fifth predefined delay period between the second positioning of the second characteristic in the output buffer and the activation time, and/or wherein the first predefined delay period and/or the second predefined delay period and/or the third predefined delay period and/or the fourth predefined delay period and/or the fifth predefined delay period and/or the sixth predefined delay period are pre-stored in the second microcontroller unit of the sensor unit.

This may achieve the technical advantage that the sum of the second predefined delay period and the fifth predefined delay period and the third predefined delay period fixes the transmission time of the response message in relation to the receipt time of the trigger message.

The transmission of the response message is thus synchronized with the receipt of the trigger message.

By installing the first to sixth predefined delay periods in the second microcontroller unit, which remain unchanged during operation of the sensor system, the temporal synchronization of the receipt of the trigger message and the transmission of the response message is ensured.

This ensures, in a technically simple manner, that the data communication between the controller and the sensor unit is deterministic.

According to an embodiment, the sixth predefined delay period between the receipt time and the measurement time is defined as the sum of the second predefined delay period between the first positioning of the first characteristic in the input buffer and the second positioning of the second characteristic in the output buffer, and the fifth predefined delay period between the second positioning of the second characteristic in the output buffer and the activation time, and the fourth predefined delay period between the activation time and the measurement time.

This may achieve the technical advantage of ensuring that the data acquisition for receiving the trigger message is fixed in time.

The measurement time is fixed by the sixth predefined delay period with the receipt time of the trigger message.

The sixth delay period is the sum of the second predefined delay period and the fourth predefined delay period.

By installing the delay periods in the second microcontroller unit of the sensor unit, temporal synchronization between the receipt of the trigger message and the recording of the sensor data by the sensor element may thus be ensured.

According to an embodiment, the method further comprises:
triggering a transmission module of the sensor unit to transmit the response message at the transmission time via the activated timer unit in a triggering step, wherein the transmission module is connected to the two-wire physics and configured to transmit the response message via the two-wire physics; and/or
triggering a recording of sensor data from a sensor element of the sensor unit by the activated timer unit at the measurement time in a further triggering step.

This may achieve the technical advantage of ensuring technically accurate execution of the transmission of the response message and the recording of the sensor data.

According to an embodiment, the processing step comprises:
determining sensor information based on the sensor data of the sensor element by the second microcontroller unit of the sensor unit in a sensor information determining step; and
wherein the second writing step comprises: writing the sensor information to the data section of the response message in the output buffer of the serial communication interface unit by the second microcontroller unit of the sensor unit in an information writing step.

This may achieve the technical advantage of ensuring technically accurate processing of the sensor data from the sensor element by generating corresponding sensor information via the CPU element of the second microcontroller unit.

The generation of the sensor information may comprise processing the raw data of the sensor element into a format that may be read and evaluated by the controller.

According to an embodiment, the data section is located in a final section of the response message.

This may achieve the technical advantage of allowing the controller to evaluate the response message as easily as possible.

Furthermore, this ensures that the time of data acquisition of the measurement data by the sensor unit is spaced as closely as possible to the time of transmission of the response message and/or to the time of receipt of the response message by the controller.

According to an embodiment, the first writing step, the second writing step, and the processing step are executed in execution cycles, wherein the first writing step, the second writing step, and the processing step are executed simultaneously in the execution cycles, and wherein, during the simultaneous execution in the first writing step, second writing step and processing step, different parts of the trigger message and/or response message are taken into account.

This may achieve the technical advantage that by simultaneously executing the processing of the trigger message and the generation of the response message, the sensor unit may achieve the shortest possible processing time.

In this case, different parts of the trigger message or response message are taken into account during the simultaneous execution of the various steps. For example, parts of the trigger message may be read in simultaneously, and other parts of the trigger message that have already been read in may be processed, and parts of the response message may be generated based on this.

Accordingly, parts of the response message may already be sent while the sensor element is still recording the sensor data and processing the sensor data into sensor information.

According to an embodiment, in the execution cycles, groups of data bits of the trigger message are written to the input buffer in the first writing step, wherein in the processing step, the data bits of a group of the trigger message written to the input buffer are processed together, and wherein in the second writing step in the execution cycles, groups of processing results are written to the output buffer.

This may achieve the technical advantage that by grouping the information in the trigger message and by jointly processing the grouped data information, the response message may be generated as quickly as possible based on the received trigger message.

According to an embodiment, the trigger message and the response message are each embodied as a telegram with at least one start section and at least one data section, wherein the start section comprises a plurality of level changes and defines a start of the respective telegram.

This may achieve the technical advantage that the telegram form of the trigger message and response message allow for reliable data communication.

The start section with the multiple level changes simplifies the receipt and identification of the respective message by the sensor unit or controller.

According to an embodiment, the first temporal positioning of the trigger message in the input buffer is determined based on a temporal positioning of a first characteristic of the trigger message in the input buffer, wherein the second temporal positioning of the response message in the output buffer is determined based on a temporal positioning of a second characteristic of the response message in the output buffer corresponding to the first characteristic of the trigger message.

This may achieve the technical advantage of allowing for a precise temporal determination of the temporal positioning of the trigger message and response message in the input buffer and output buffer of the serial communication interface unit, respectively.

For this purpose, a first characteristic is defined in the trigger message and a corresponding second characteristic in the response message.

The temporal positioning of the first characteristic of the trigger message in the input buffer is identified accordingly as the first temporal positioning of the trigger message in the input buffer, while, analogously, the temporal positioning of the second characteristic of the second temporal positioning of the response message corresponds to the output buffer.

According to an embodiment, the first characteristic and/or the second characteristic is defined as a predefined sequence of high levels and/or low levels.

This may achieve the technical advantage that the predefined sequence of high levels and/or low levels for defining the first characteristic and/or second characteristic allows for easily identifying the respective characteristics in the trigger message and/or response message.

This allows for positioning of the trigger message in the input buffer to be determined precisely in terms of time.

This, in turn, allows for precisely positioning the trigger message in the input buffer according to the determined receipt time.

According to an embodiment, the first characteristic in the trigger message and the second characteristic in the response message each define a start-of-frame section.

This may achieve the technical advantage of a distinctive definition of the first and second characteristics.

According to an embodiment, the receiving step comprises:
sampling the trigger message at an oversampling rate via the serial communication interface unit of the second microcontroller unit in a sampling step.

This may achieve the technical advantage that sampling the trigger message at an oversampling rate by the serial communication interface unit allows for precise receipt of the trigger message.

Oversampling ensures that no information from the trigger message is lost. In the method according to the application, it is not necessary for the sensor unit to know that, and when, a trigger message is sent by the controller.

The sensor unit therefore does not recognize the times at which sampling of the transmission lines would be necessary to detect the trigger message. Oversampling thus ensures that the relevant information in the trigger message may still be detected.

Oversampling in this context means that sampling is carried out at a sampling frequency that is higher than the frequency at which the information in the trigger message is arranged.

According to an embodiment, majority decisions are executed by the second microcontroller unit during oversampling by the serial communication interface unit.

This offers the technical advantage that majority decisions during sampling may be used to clearly identify the various characteristics of the trigger message.

The majority decisions may also increase the interference immunity of the method.

According to an embodiment, the determined receipt time of the trigger message is defined by a sampling time of the sampling of the first characteristic of the trigger message by the serial communication interface unit.

This may achieve the technical advantage of defining a precise receipt time.

In this context, the receipt time is defined as the time at which the first characteristic of the trigger message is sampled.

This allows for precisely determining the time of receipt of the temporally extended trigger message.

The first temporal positioning of the response message within the input buffer of the serial communication interface unit corresponds to the sampling time at which the first characteristic of the trigger message is sampled.

When the trigger message is sampled, the sample information is simultaneously written to the input buffer of the serial communication interface unit.

The sampled information of the trigger message is written to the corresponding temporal positions of the input buffer according to the respective sampling times.

The sampling time of the first characteristic of the trigger message thus corresponds to the temporal positioning of the first characteristic of the trigger message in the input buffer of the serial communication interface unit.

According to an embodiment, the sampling step is carried out in the execution cycles, wherein a length of the start section of the trigger message and/or a length of the start section of the response message corresponds to at least a maximum number of samples that may be carried out per execution cycle.

This may achieve the technical advantage that, in any case, the start section may be sampled and thus identified in an execution cycle.

According to an embodiment, a section positioned temporally before the response message in the output buffer of the serial communication interface unit is filled with zero bits.

This may achieve the technical advantage that exclusively the information of the response message is written to the output buffer.

For this purpose, in each execution cycle, the two-wire physics is read out by scanning, the correspondingly read-out information is written to the input buffer, the information written to the input buffer is processed, and the information generated by the processing is written to the output buffer.

By filling the output buffer with zero bits, this process may be maintained without placing incorrect information in the output buffer.

According to an embodiment, bit boundaries are generated in the trigger message and/or the response message by a toggle method.

This may achieve the technical advantage that clearly defined information may be transmitted in the trigger message or response message.

According to an embodiment, the serial communication interface unit is embodied as an SPI interface unit.

This may achieve the technical advantage that a powerful communication interface unit may be provided by configuring the serial communication interface unit as an SPI interface unit.

According to an embodiment, the serial communication interface unit is operated as a serial/parallel converter.

This may achieve the technical advantage that precise processing of the trigger message and generation of the response message is enabled.

According to an embodiment, the processing step is carried out by a CPU element of the second microcontroller unit, wherein the CPU element comprises an interrupt request IRQ.

This may achieve the technical advantage that, because the CPU element of the second microcontroller unit comprises an interrupt request IRQ, the CPU element may be embodied as simply as possible while still being capable of executing the method according to the application.

According to an embodiment, the frame of sensor information transmitted in the response message from the sensor unit to the controller is decoded and/or processed coherently by the first microcontroller unit of the controller.

This may achieve the technical advantage of allowing for time-saving processing of the information in the response message by the control message.

According to an embodiment, the first microcontroller unit of the controller comprises a further serial communication interface unit, wherein the further serial communication interface unit of the first microcontroller unit of the controller and the serial communication interface unit of the second microcontroller unit of the sensor unit are each operated in a controller mode.

This may achieve the technical advantage of allowing for precise data communication between the controller and the sensor unit.

According to an embodiment, the first predefined delay period is larger than or equal to a receipt period for the sensor unit to receive the trigger message, wherein the receipt period is defined as the period between the receipt of the first characteristic of the trigger message and the receipt of a last characteristic of the trigger message.

This may achieve the technical advantage of ensuring that the response message is only sent after the trigger message has been completely received by the sensor unit.

Both the trigger message and the response message are in telegram form and thus have a temporal extension. The trigger message is therefore received over a continuous receipt period, which may extend over several execution cycles.

By making the first predefined delay period between the receipt time and the transmission time equal to or larger than the receipt time required for complete receipt of the trigger message, it is possible to prevent the response message from being transmitted before the trigger message has been received entirely.

Since only two transmission wires are available for data transmission in two-wire physics, and since the trigger message is sent from the controller to the sensor unit and the response message is sent from the sensor unit to the controller via the same transmission wires, the simultaneous transmission of trigger messages from the controller to the sensor unit and of response messages from the sensor unit to the controller could lead to information loss.

By setting the first predefined delay period accordingly, the sensor unit may thus be operated in a receipt mode in which the sensor unit exclusively receives the trigger message or reads it from the two-wire physics, and in a transmission mode in which the sensor unit exclusively transmits the corresponding response message via the two-wire physics.

Receiving and transmitting does not take place simultaneously.

The first predefined delay period, which is pre-stored in the second microcontroller unit of the sensor unit, and the use of the timer unit, which triggers the transmission module to transmit the response message, make it possible to avoid additional active switching of the sensor unit between the receipt mode and the transmission mode.

According to an embodiment, data communication between the controller and the sensor unit takes place in a half-duplex mode.

This may achieve the technical advantage that, by operating in half-duplex mode via the same transmission wires of the two-wire physics, data communication between the controller and the sensor unit may be achieved in both directions.

According to an embodiment, in addition to data communication, energy transmission between the controller and the sensor unit is achieved via the two-wire physics.

This may achieve the technical advantage that no additional transmission wires are required for energy transfer between the controller and the sensor unit.

According to an embodiment, the serial communication interface unit of the sensor unit and/or the additional serial communication interface unit are operated with an unassigned clock channel and/or an unassigned chip select channel.

This may achieve the technical advantage that the method according to the application does not require any additional clock signal or chip select signal for the SPI interface.

Accordingly, the SPI interface unit may be operated with the two transmission wires of the two-wire physics.

According to an aspect, a sensor system is provided with at least one controller and one sensor unit, wherein the controller and the sensor unit are connected to each other via a two-wire physics, wherein data communication between the controller is realized via the two-wire physics, wherein the controller comprises a first microcontroller unit and the sensor unit comprises a second microcontroller unit for carrying out the data communication, and wherein the sensor system is embodied to execute the method according to one of the preceding embodiments.

This may achieve the technical advantage of providing an improved sensor system that is configured to carry out the method according to the application with the technical advantages described above.

According to an embodiment, the sensor unit comprises a timer unit, a sensor element, and a transmission module, wherein the microcontroller unit of the sensor unit comprises a serial communication interface unit, wherein a data output channel of the serial communication interface unit is connected to the transmission module and the timer unit, wherein the timer unit is connected to the sensor element and the transmission module, and wherein the transmission module is connected to the two-wire physics.

This may achieve the technical advantage that, by connecting the serial communication interface unit to the timer unit and the timer unit to the sensor element or the transmitter module, the timer unit may be activated by the response message sent to the data output channel of the serial interface unit.

This means that no additional activation signal is required to activate the timer unit, which is used to trigger the transmitter module or the sensor element.

This minimizes the number of components required in the sensor unit.

According to an embodiment, the sensor element is embodied as one of the following: position sensor element, temperature sensor element, vibration sensor element, acceleration sensor element.

This may achieve the technical advantage that the present application is applicable to a variety of different sensor types.

### Representative Configurations

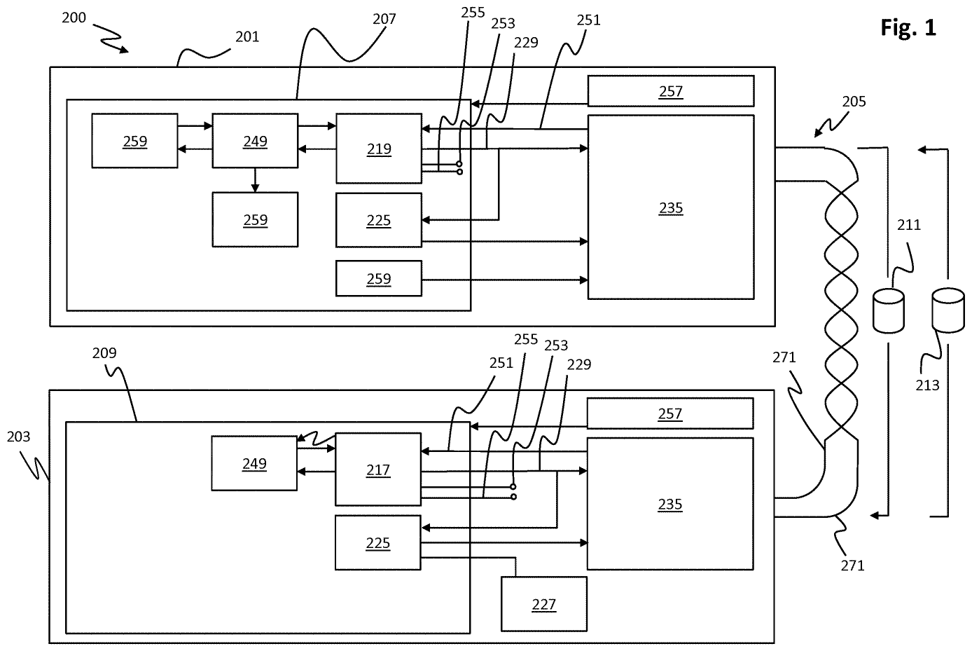

FIG. 1 shows a schematic depiction of a sensor system 200 according to an embodiment.

In the embodiment shown, the sensor system 200 comprises a controller 201 and a sensor unit 203. The controller 201 and the sensor unit 203 are connected to each other for data transfer via a two-wire physics 205 with two transmission wires 271.

The controller 201 comprises a first microcontroller unit 207. The sensor unit 203 comprises a second microcontroller unit 209.

The controller 201 and the sensor unit 203 are configured to carry out data communication via the two-wire physics 205 via the first and second microcontroller units 207, 209.

For this purpose, the controller 201 may send a trigger message 211 to the sensor unit 203, which is received by the sensor unit 203.

The trigger message 211 may, for example, trigger the recording of sensor values from a sensor element 227 of the sensor unit 203.

The sensor unit 203 is also configured, via the second microcontroller unit 209, to read out and process the received trigger message 211 and to transmit a corresponding response message 213 to the controller 201 via the two-wire physics 205.

The response message 213 may in particular contain the sensor data or sensor information recorded by the sensor element 227.

Sensor information may be based on the sensor data recorded by the sensor element 227 and may have been generated by processing by the second microcontroller unit 209.

The sensor information may, for example, comprise the recorded sensor data translated into a format readable by the controller 201.

To carry out data communication between the controller 201 and the sensor unit 203, the method according to the application for operating a sensor system is to be carried out by the second microcontroller unit 209. For this purpose, the second microcontroller unit 209 receives the trigger message 211 sent by the controller 201 and determines a receipt time.

After determining the receipt time T_rec, the second microcontroller unit 209 determines a transmission time T_send for transmitting the response message 213.

The second microcontroller unit 209 then processes the received trigger message 211 and generates a corresponding response message 213.

The response message 213 is then transmitted to the controller 201 via the two-wire physics 205 at the transmission time T_send.

The second microcontroller unit 209 of the controller 201 is thus configured to provide data communication which is synchronized with regard to time with the controller 201.

The first predefined delay period may be pre-stored in the second microcontroller unit 209 of the sensor unit 203 for this purpose.

The first predefined delay period DT1 thus ensures that after the trigger message 211 is received by the sensor unit 203 at any receipt time T_rec, the corresponding response message 213 is sent by the sensor unit 203 exactly after the first predefined delay period DT1 has elapsed after the trigger message 211 was received at the receipt time T_rec.

The second microcontroller unit 209 of the sensor unit 203 is also configured to initiate the measurement of the sensor data by the sensor element 227 at a measurement time T_dat after receiving the trigger message 211 at the receipt time T_rec.

The measurement time T_dat is distanced from the receipt time T_rec by a sixth predefined time interval DT6.

The sixth predefined time interval DT6 may in turn be preset in the second microcontroller unit 209.

The sixth predefined time interval DT6 may be used to link the data acquisition at the measurement time T_dat to the receipt of the trigger message 211 at the receipt time T_rec. This allows the acquisition of the measured values to be synchronized with the receipt of the trigger message 211.

After receiving the trigger message 211 at the receipt time T_rec, the sensor data is recorded by the sensor element 227 exactly after the sixth predefined time period DT6 has elapsed.

The first predefined delay period DT1 and the sixth predefined delay period DT6 synchronize both the transmission of the response message 213 at the transmission time T_send and the recording of the sensor data by the sensor element 227 for receiving the trigger message 211 at the receipt time T_rec.

In the embodiment shown, the second microcontroller unit 209 of the sensor unit 203 comprises a serial communication interface unit 217 and the first microcontroller unit 207 of the controller 201 comprises a further serial communication interface unit 219.

The serial communication interface units 217, 219 may, for example, be embodied as SPI interface units.

In the embodiment shown, the second microcontroller unit 209 also comprises a timer unit 225. The sensor unit 203 additionally comprises a transmitter module 235.

The transmitter module 235 is connected to the two-wire physics 205 on the one hand and to the timer unit 225 and the communication interface unit 217 on the other hand.

The sensor element 227 is also connected to the timer unit 225 for data transfer.

The timer unit may be set up to switch the transmitter module 235 into a transmission mode for transmitting the response message 213.

The timer unit 225 may also be set up to trigger the sensor element 227 to record the sensor data.

In the embodiment shown, the first and second microcontroller units 207, 209 also comprise CPU elements 249.

According to an embodiment, the CPU elements 249 may each comprise an input for interrupt requests (IRQ).

The CPU elements 249 are each connected to the serial communication interface units 217, 219 for data transfer.

In the embodiment shown, the controller 201 and the sensor unit 203 also comprise a clock generator 257.

In the embodiment shown, the first microcontroller unit 207 of the controller 201 also comprises further processing components 259, such as a RAM.

In the embodiment shown, the serial communication interface units 217, 219 each comprise a data input channel 251, a data output channel 229, a clock channel 253, and a chip select channel 255.

In the embodiment shown, the clock channel 253 and the chip select channel 255 of the serial communication interface units 217, 219 are each unassigned.

The data input channel 251 and the data output channel 229 are each connected to the transmission module 235. In the embodiment shown, the data output channel 229 is also connected to the timer unit 225 in terms of data technology.

The serial communication interface unit 217 is set up via the data input channel 251 to receive the trigger message 211 transmitted by the controller 201 via the two-wire physics 205.

The serial communication interface unit 217 is also configured to determine the receipt time T_rec of the trigger message 211.

The trigger message 211 received by the serial communication interface unit 217 is processed via the CPU element 249 and a corresponding response message 213 is generated.

The response message 213 may subsequently be forwarded by the serial communication interface unit 217 via the data output channel 229 to the transmission module 235 for transmission to the controller 201.

By connecting the data output channel 229 to the timer unit 225, the response message 213 provided by the communication interface unit 217 on the data output channel 229 may also be used as an input signal for the timer unit 225.

The timer unit 225 is activated by the response message 213 provided on the data output channel 229.

The activation of the timer unit 225 may be achieved by the level changes of the response message 213. The response message 213 does not need to include an explicit activation signal to activate the timer unit 225.

Instead, activation may be achieved solely by placing the response message 213 on the data output channel 229.

After activation, the timer unit 225 switches the transmission module 235 to a transmission mode after a third predefined delay period in order to transmit the response message 213 and/or triggers the sensor element 227 to record the sensor data after a fourth delay period DT4.

The timer unit 225 may be integrated into the respective microcontroller unit 207, 209 or embodied as a peripheral component external to the respective microcontroller unit 207, 209.

According to an embodiment, the microcontroller units 207, 209 may also additionally comprise programmable logic elements. These logic elements may be embodied in such a way that they start the activation of the timer unit 225 and trigger the measurements based on the transmission of the response message 213 by the communication interface unit 217.

In this embodiment, the activation of the timer unit 225 may also be achieved by the level changes of the response message 213.

The programmable logic elements may in this context be set up to determine the receipt time T_rec of the receipt of the trigger message 211.

Furthermore, the first delay period DT1 and/or the transmission time T_send and/or the sixth delay period DT6 and/or the measurement time T_dat may be stored in the programmable logic elements.

Based on this, the programmable logic elements may, after receiving the trigger message 211, initiate the transmission of the response message 213 at the transmission time T_send and/or the recording of the sensor values at the measurement time T_dat.

According to an embodiment, the sensor element 227 is embodied as a sensor element from the following list: position sensor element, temperature sensor element, vibration sensor element, acceleration sensor element. Alternatively, other sensor types or combinations may also be considered.

According to an embodiment, in addition to data communication between the controller 201 and the sensor unit 203, energy transfer is also carried out via the two-wire physics 205.

According to an embodiment, data communication between the controller 201 and the sensor unit 203 is carried out in a half-duplex mode.

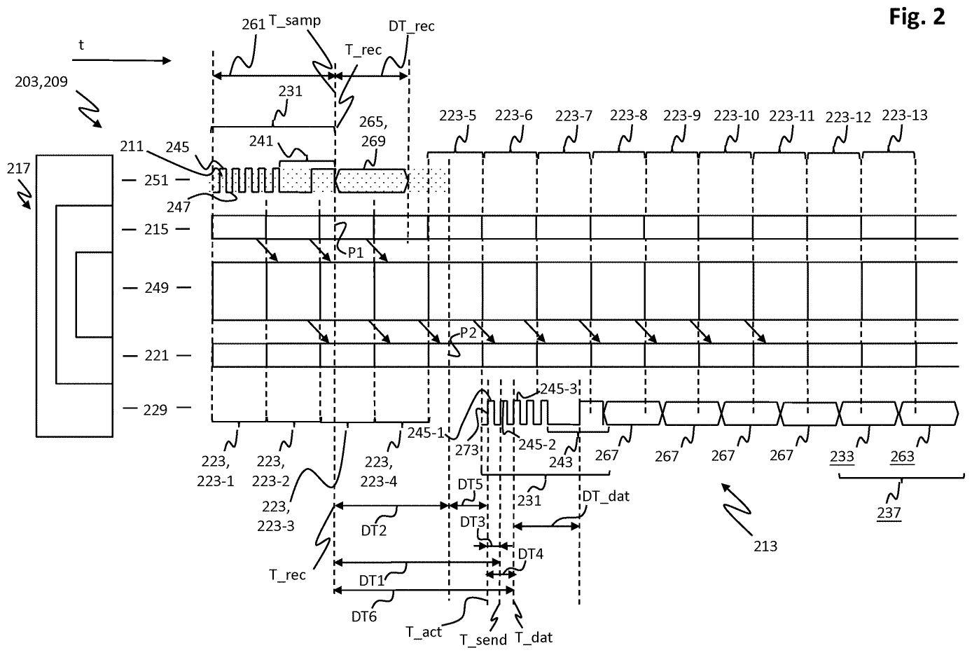

FIG. 2 shows a schematic depiction of data communication between a controller 201 and a sensor unit 203 of the sensor system 200 according to an embodiment.

FIG. 2 graphically shows various method steps of the method according to the application for operating the sensor system 200.

For this purpose, various processes carried out by the individual components of the second microcontroller unit 209 of the sensor unit 203 are shown in chronological order.

In the embodiment shown, the serial communication interface unit 217 and the CPU element 249 of the microcontroller unit 209 are shown.

The data input channel 251 and the data output channel 229 of the serial communication interface unit 217 are shown.

Furthermore, an input buffer 215 and an output buffer 221 of the serial communication interface unit 217 are shown in the embodiment shown.

According to the application, the trigger message 211 sent by the controller 201 is received at a receipt time T_rec by the second microcontroller unit 209 and, in particular, by the serial communication interface unit 217.

For this purpose, the serial communication interface unit 217 reads out the data input channel 251.

According to an embodiment, reading out the data input channel 251 comprises sampling the data input channel 251 at an oversampling rate.

The sampling rate may, for example, comprise four times the frequency of the transmission rate of the trigger message 211.

According to an embodiment, during oversampling by the serial communication interface unit 217, majority decisions are carried out by the second microcontroller unit 209 to identify the characteristics of the trigger message 211.

According to an embodiment, a length of the start section 231 of the trigger message 211 and/or a length of the start section 231 of the response message 213 corresponds to at least a maximum number of samples that may be executed per execution cycle 223.

In the embodiment shown, the sampled values are then written to the input buffer 215 of the serial communication interface unit 217 in order to receive the trigger message 211.

In the embodiment shown, the trigger message 211 is in telegram form. The trigger message 211 comprises a start section 231 for this purpose.

Via the start section 231 in conjunction with the trigger section 265, the serial communication interface unit 217 and/or the second microcontroller unit 209 is able to recognize the trigger message 211 as a message.

The trigger message 211 also comprises at least the trigger section 265. The trigger section 265 identifies the trigger message 211 as a trigger message 211.

Bit boundaries may be generated in the trigger message 211 and/or the response message 213 by a corresponding toggle procedure.

By processing the information of the trigger section 265, the second microcontroller unit 209 of the sensor unit 203 is stimulated to cause the sensor element 227 to record the sensor data and/or to generate and transmit a corresponding response message 213.

In the embodiment shown, the start section 231 comprises a plurality of level changes between a plurality of high levels 245 and low levels 247.

Following the plurality of level changes, the start section 231 comprises a first characteristic 241. In the embodiment shown, the first characteristic 241 is formed as a predefined number and/or durations of temporally successive high levels 245 and low levels 247.

According to an embodiment, the first characteristic 241 in the trigger message 211 and/or the second characteristic 243 in the response message 213 each define a start-of-frame section of the respective message.

According to the embodiment shown, the receipt time T_rec at which the trigger message 211 is received by the second microcontroller unit 209 of the sensor unit 203 is defined as a sampling time T_samp of the first characteristic 241.

As mentioned above, the sample values generated in the sampling of the data input channel 251 are then written to the input buffer 215 of the serial communication interface unit 217.

The sample values of the sampling are written to the input buffer 215 according to the sampling times at which they were sampled during the sampling.

The first characteristic 241 of the trigger message 211 is stored accordingly in a first temporal position P1 in the input buffer 215. The first temporal position P1 of the first characteristic 241 in the input buffer 215 represents the receipt time T_rec.

The first temporal positioning P1 of the first characteristic 241 may, for example, be defined as a point in time of a rising edge of the first characteristic 241. Alternatively, the first temporal positioning P1 may also be defined as a point in time of a falling edge.

According to the application, after determining the receipt time T_rec, the transmission time T_send at which the response messages 213 are to be transmitted is determined.

According to the application, the transmission time T_send is distanced from the receipt time T_rec by the first predefined delay period DT1.

The transmission time T_send determined in this way does not represent an absolute time determination, but is primarily characterized as a time that is distanced from the receipt time T_rec by the first predefined delay period DT1.

In the embodiment shown, a second temporal positioning P2 is determined in the output buffer 221 based on the previously determined receipt time T_rec in order to determine the transmission time T_send.

The second temporal positioning P2 describes a temporal positioning of a second characteristic 243 of the response message 213 generated in the output buffer 221 of the serial communication interface unit 217 by executing the processing steps with the aid of the CPU element 249 based on the information of the received trigger message 211.

The second temporal positioning P2 of the second characteristic 243 of the response message 213 in the output buffer 221 is temporally distanced by a second predefined delay period DT2 from the first temporal positioning P1 of the first characteristic 241 of the trigger message 211 in the input buffer 215.

The second temporal positioning P2 of the second characteristic 243 may, for example, be defined as a point in time of a rising edge of the second characteristic 243. Alternatively, the second temporal positioning P2 may also be defined as a point in time of a falling edge.

The second predefined delay period DT2 is also predefined and stored in advance in the second microcontroller unit 209.

The second predefined delay period DT2 describes a time offset by which characteristics of the response message 213 are stored in the output buffer 221 relative to the respective characteristics of the response message 213 corresponding to characteristics of the trigger message 211 in the input buffer 215.

In the embodiment shown, the method is carried out cyclically in the second microcontroller unit 209.

Sampling the data input channel 251, writing to the input buffer 215, processing the information of the trigger message 211 by the CPU element 249, writing the response message 213 to the output buffer 221, and providing the corresponding response message 213 to the data output channel 229 are carried out in a plurality of temporally successive execution cycles 223.

For example, FIG. 2 shows 13 successive execution cycles 223-1, . . . , 223-13.

In the embodiment shown, the first characteristic 241 of the trigger message 211 is determined in a third execution cycle 223-3 by appropriately sampling the data input channel 251 and is written to the input buffer 215 at the first temporal position P1.

The first temporal positioning P1 of the first characteristic 241 in the input buffer 215 is thus shown in the third depicted execution cycle 223-3.

The corresponding second characteristic 243 of the response message 213 is positioned in the second temporal positioning P2 in the output buffer 221. In the embodiment shown, the second temporal positioning P2 is located in a fifth execution cycle 223-5.

In the event of a temporal extension of the second characteristic 243, the second temporal positioning P2 may be defined, for example, as the temporal positioning of a first bit, last bit, or selected bit of the second characteristic 243.

The second predefined delay period DT2, by which the first positioning P1 of the first characteristic 241 of the trigger message 211 in the input buffer 215 is spaced apart in time from the second temporal positioning P2 in the output buffer 221 of the second characteristic 243 of the corresponding response message 213, thus comprises at least one execution cycle 223-4 in the embodiment shown.

In the embodiment shown, the information of the received trigger message 211 written to the input buffer 215 is processed by the CPU element 249 in a later execution cycle 223.

The information generated by the processing is written to the output buffer 221 in an execution cycle 223 that is later in time than the processing is carried out.

In the embodiment shown, for example, the first characteristic 241 is detected in the third execution cycle 223-3 and written to the input buffer 215 accordingly.

The information of the first characteristic 241 is processed by the CPU element 249 in a fourth execution cycle 223-4.

In the embodiment shown, the first characteristic 241 extends from the third execution cycle 223-3 into the fourth execution cycle 223-4. The processing of the first characteristic 241 may thus also take place over two execution cycles, for example the fourth execution cycle 223-4 and the fifth execution cycle 223-5.

The processing results generated in the fourth execution cycle 223-4 are then written to the output buffer 221 in the fifth execution cycle 223-5.

This time offset between writing the information to the input buffer 215, processing the information in the input buffer 215 with the aid of the CPU element 249, and writing the information generated by the processing to the output buffer 221 allows for the individual characteristics of the trigger message 211 written to the input buffer 215 to be uniformly distanced by the second predefined delay period DT2 from the corresponding characteristics of the response message 213 in the output buffer 221.

The time offset between the processing of the trigger message 211 to generate the response message 213 and the writing of the information of the generated response message 213 to the output buffer 221 may compensate for temporal irregularities with which the processing results may be provided by the CPU element 249.

The communication interface 217 and the microcontroller unit 209 may be operated asynchronously in this case.

According to an embodiment, the CPU element 249 includes an interrupt request IRQ. In the case of an interrupt request, it is not possible to determine at what point in time the processing results of the interrupt request will be provided within an execution cycle 223 in which the processing was performed by the interrupt request.

However, by writing the processing results of the interrupt request to the output buffer 221 in the next execution cycle 223, as shown in FIG. 2, it may be ensured that all characteristics of the response message 213 generated by the processing in the output buffer 221 are temporally distanced by the second predefined delay period DT2 from the corresponding characteristics of the trigger message 211 in the input buffer 215, since the buffers 215 and 221 operate synchronously with each other.

The second predefined delay period DT2 is a predefined part of the first predefined delay period DT1, which separates the receipt time T_rec from the transmission time T_send.

In the embodiment shown, writing information to the input buffer 215, processing the information in the input buffer 215, and writing information to the output buffer 221 are carried out simultaneously in each execution cycle 223.

In the execution cycles 223 in which no trigger message 211 is received and thus no information may be sampled from the data input channel 251, zero bits are written to the input buffer 215, for example.

Similarly, the area in the output buffer 221 in which no information or data from the response message 213 is written may be filled with corresponding zero bits.

According to the embodiment shown in FIG. 1, the second microcontroller unit 209 of the sensor unit 203 comprises a timer unit 225. After activation of the timer unit 225, the timer unit 225 may switch the transmission module 235 to transmission mode for transmitting the response message 213.

Furthermore, the timer unit 225 may be set up to trigger the recording of sensor data by the sensor element 227 after activation.

According to the embodiment shown in FIG. 1, the sensor element 227 is triggered by the response message 213 generated by the CPU element 249 and written to the output buffer 221 being placed on the data output channel 229.

In the embodiment shown, the response message 213 is also in telegram form and comprises a start section 231 with a plurality of level changes and the second characteristic 243.

In the embodiment shown, in a sixth execution cycle 223-6, the correspondingly generated response message 213 is placed from the output buffer 221 onto the data output channel 229. This results in the activation of the timer unit 225 at an activation time T_act.

In the embodiment shown, the timer unit 225 is activated by a rising edge 273 of a first high level 245-1 of the start section 231 of the response message 213.

After activation, the timer unit 225 triggers the transmission module 235 at a transmission time T_send. By triggering the transmission module 235, the transmission module 235 places the response message 213 on the two-wire physics 205.

In the embodiment shown, the transmission time T_send is exemplarily equated with the rising edge 273 of a second high level 245-2 of the start section 231 of the response message 213.

In addition, the timer unit 225 triggers the recording of the sensor data by the sensor element 227 at a measurement time T_dat. In the embodiment shown, the measurement time T_dat corresponds to the rising edge of a third high level 245-3 of the start section 231.

According to the embodiment shown, the transmission time T_send is distanced from the activation time T_act by a third predefined delay period DT3.

In the embodiment shown, the measurement time T_dat is distanced from the activation time T_act of the timer unit 225 by a fourth predefined delay period DT4.

The third predefined delay period DT3 and the fourth predefined delay period DT4 may be stored in the timer unit 225.

When the timer unit 225 is activated by the response message 213 as an input signal to the timer unit 225, the transmission module 235 is automatically triggered by the timer unit 225 after the third predefined delay period DT3 has elapsed.

The response message 213 is then transmitted by the transmission module 235 via the two-wire physics 205.

Similarly, after the fourth predefined delay period DT4 has elapsed following the activation time T_act, the sensor element 227 is automatically triggered by the timer unit 225 to record the sensor data.

As may be seen in FIG. 2, the transmission time T_send is distanced from the receipt time T_rec by the first predefined delay period DT1.

In the embodiment shown, the first predefined delay period DT1 results from the sum of the second predefined delay period DT2 between the first time position P1 of the first characteristic 241 of the trigger message 211 in the input buffer 215 and the second time position P2 of the second characteristic 243 of the response message 213 in the output buffer 221 and a fifth predefined delay period DT5 between the second temporal positioning P2 and the activation time T_act and the third predefined delay period DT3 between the activation time T_act of the activation of the timer unit 225 and the transmission time T_send.

The measurement time T_dat of the recording of the sensor data by the sensor element 227 is further temporally distanced by the sixth predefined delay period DT6 from the receipt time T_rec of the receipt of the trigger message 211.

As may be seen from FIG. 2, the sixth predefined time interval DT6 results from the sum of the second predefined delay time interval DT2, the fifth predefined delay time interval DT5, and the fourth predefined delay time interval between the activation time T_act and the measurement time T_dat.

The fifth predefined delay period DT5 is also pre-stored in the second microcontroller unit 209 and specifies the time offset between the second time position P2 of the second characteristic 243 of the response messages 213 in output buffer 221 and the activation of the timer unit 225 at the activation time T_act.

As already mentioned above, the reading or receiving of the trigger message 211, the processing of the trigger message 211 and the generation of the corresponding response message 213, and the actual transmission of the response message 213 take place simultaneously.

Accordingly, parts of the response message 213 may already be sent by the transmission module 235 while other parts of the response message 213 are still being generated by processing by the CPU element 249.

In the embodiment shown, the exemplary response message 213 comprises a plurality of communication sections 267 following the start section 231. In the communication sections 267, communication information may be provided by the sensor unit 203 of the controller 201.

After the communication sections 267, the response message 213 further comprises a data section 233. The sensor information of the sensor element 227 is written into the data section 233.

In the embodiment shown, the response message 213 further comprises a checksum section 263 at the end. The data section 233 and the checksum section 263 are arranged in a final section 237 of the response message 213.

In the example shown, the transmission module 235 is triggered to transmit the response message 213 at the transmission time T_send in the sixth execution cycle 223-6.

In the example shown, the transmission of the response message 213 at the transmission time T_send thus takes place in the sixth execution cycle 223-6.

Also in the sixth execution cycle 223-6, data acquisition by the sensor element 227 is triggered at the measurement time T_dat.

In the embodiment shown, the sensor data is recorded by the sensor element 227 during a measurement period DT_dat.

The measurement period DT_dat runs, for example, from the measurement time T_dat in the sixth execution cycle 223-6 to the seventh execution cycle 223-7.

The sensor data of the sensor element 227 recorded during the measurement period DT_dat is processed by the CPU element 249 in an eighth execution cycle 223-8 in accordance with the time offset.

The processing of the sensor data from sensor element 227 with the aid of CPU element 249 may include, for example, the generation of sensor information.

The sensor information is based on the sensor data from sensor element 227 and may, for example, be translated into a form that may be read by the controller 201.

The sensor information generated by the CPU element 249 in the eighth execution cycle 223-8 is then written to the output buffer 221 in the ninth execution cycle 223-9. The corresponding sensor information forms the data section 233 of the response message 213 written to the output buffer 221.

In the embodiment shown, the sensor information of data section 233 of response message 213 is applied in a twelfth execution cycle 223-12 from the output buffer 221 to the data output channel 229 of the serial communication interface unit 217 and transmitted via the two-wire physics 205 by the transmission module 235 already triggered in the sixth execution cycle 223-6.

In the example shown, the response message 213 is thus transmitted by the transmission module 235 from the sixth execution cycle 223-6 to the thirteenth execution cycle 223-13.

The execution of the response message 213 shown here is merely an example.

As already described above, both the response message 213 and the trigger message 211 comprise a temporal extension.

The receipt of the response message 211 is defined by the receipt time T_rec. However, the receipt process of the entire trigger message 211 is characterized by an extended receipt time period DT_rec.

The receipt period DT_rec is defined between the receipt time T_rec, which in the embodiment shown is characterized by the sampling time T_samp of the first characteristic 241 of the start section 231 of the trigger message 211, and the receipt of a last characteristic 269 of the trigger message 211.

After receiving the last characteristic 269, the receipt process during the receipt time period DT_rec of the trigger message 211 is terminated by the serial communication interface unit 217.

According to the embodiment shown, the first predefined delay period DT1 between the receipt time T_rec and the transmission time T_send is larger than the receipt period DT_rec.

This means that the transmission of the response message 213 by the transmission module 235 at the transmission time T_send only takes place after the receipt process of the entire trigger message 211 via the serial communication interface unit 217 has been completed.

This ensures that trigger messages 211 are not received and response messages 213 are not sent simultaneously via the two-wire physics 205. According to the application, the transmission of the response message 213 and the receipt of the trigger message 211 are achieved by the same transmission wires of the two-wire physics 205.

According to an embodiment, the serial communication interface unit 217 is operated as a serial/parallel converter.

The serial communication interface unit 217 of the second microcontroller unit 209 of the sensor unit 203 and the further serial communication interface unit 219 of the first microcontroller unit 207 of the controller 201 are each operated in a controller mode.

According to an embodiment, the sensor information transmitted in the response message 213 from the sensor unit 203 to the controller 201 is decoded and/or processed coherently by the first microcontroller unit of the controller 201.

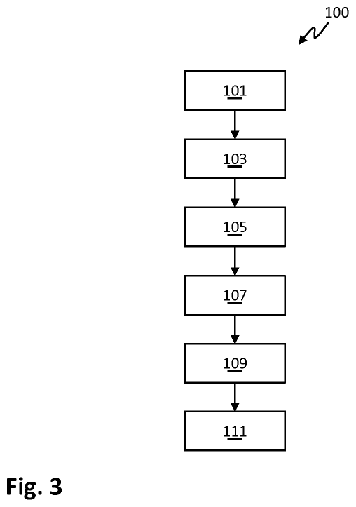

FIG. 3 shows a further schematic depiction of the data communication between the controller 201 and the sensor unit 203 of the sensor system 200 according to a further embodiment.

In order to operate the sensor system 200, the sensor unit 203 first receives a trigger message 211 sent by the controller 201 via the two-wire physics 205 in a receiving step 101.

In a receipt time determining step 103, the second microcontroller unit 209 of the sensor unit 203 determines the receipt time T_rec of the receipt of the trigger message 211.

In a transmission time determining step 105, the second microcontroller unit 209 determines the transmission time T_send for transmitting the response message 213 from the sensor unit 203 to the controller 201 based on the receipt time T_rec.

The transmission time T_send is distanced from the receipt time T_rec by the first predefined delay period DT1.

In a processing step 107, the second microcontroller unit 209 then processes the trigger message 211.

In a message generating step 109, the response message 213 is generated based on the processing of the trigger message 211 by the second microcontroller unit 209.

In a transmitting step 111, the response message 213 is then transmitted by the sensor unit 203 at the transmission time T_send.

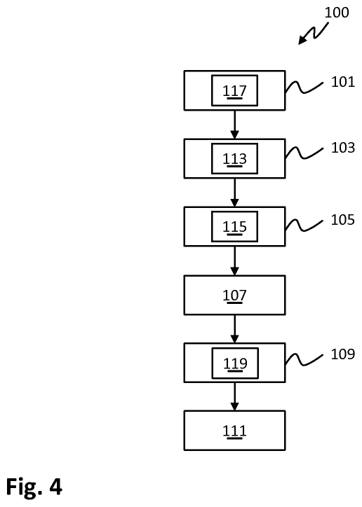

FIG. 4 shows a further schematic depiction of the sensor system 200 according to a further embodiment.

The embodiment of FIG. 4 is based on the embodiment of FIG. 3 and comprises all the method steps described therein.

In the embodiment shown, the receiving step 101 comprises a first writing step 117. In the first writing step 117, the received trigger message 211 is written to the input buffer 215 of the serial communication interface unit 217.

The receipt time determining step 103 further comprises a first positioning determining step 113. In the first positioning determining step 113, the second microcontroller unit 209 determines the first temporal positioning P1 of the trigger message 211 in the input buffer 215 of the serial communication interface unit 217.

The transmission time determining step 105 further comprises a second positioning determining step 115. In the second positioning determining step 115, the second temporal positioning P2 of the response message 213 in the output buffer 221 of the serial communication interface unit 217 is determined.

In the embodiment shown, the message generating step 109 further comprises a second writing step 119. In the second writing step 119, the generated response message 213 is written by the microcontroller unit 209 to the output buffer 221 of the serial communication interface unit 217.

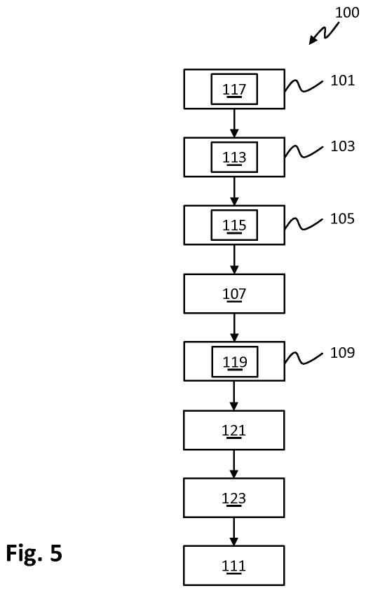

FIG. 5 shows a flowchart of a method 100 for controlling a sensor system 200 according to an embodiment.

The embodiment of FIG. 5 is based on the embodiment in FIG. 4 and comprises all the method steps described therein.

In the embodiment shown, the method further comprises an activating step 121. In the activating step 121, the second microcontroller unit 209 activates the timer unit 225 at the activation time T_act to trigger the transmission of the response message 213 at the transmission time T_send and/or to trigger data acquisition with the aid of the sensor element 227.

In a triggering step 123, the transmission module 235 is then triggered by the activated timer unit 225 to transmit the response message 213 at the transmission time T_send.

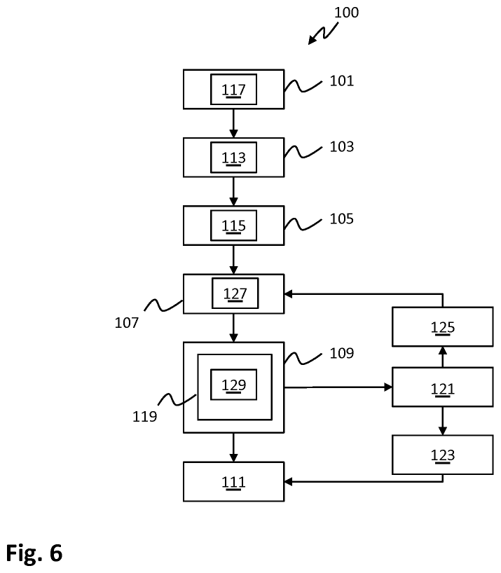

FIG. 6 shows a further flowchart of the method 100 for operating a sensor system 200 according to a further embodiment.

The embodiment in FIG. 6 is based on the embodiment in FIG. 5 and comprises all the method steps described therein.

In the embodiment shown, the method 100 further comprises a further triggering step 125.

In the further triggering step 125, the activated timer unit 225 triggers the sensor element 227 to record the sensor data at the measurement time T_dat.

Furthermore, the processing step 107 comprises a sensor information determining step 127. In the sensor information determining step 127, the second microcontroller unit 209 determines the sensor information based on the sensor data of the sensor element 227.

The second writing step 119 also includes an information writing step 129. In the information writing step 129, the sensor information generated in the sensor information determining step 127 is then written to the output buffer 221 of the serial communication interface unit 217.

As described above, the transmission of the response message 211, the recording of the sensor data, the generation of the sensor information, and the writing of the sensor information to the response message 211 occur simultaneously.

In this context, parts of the response message 211 are already sent while the data is being recorded and the sensor information based on this data is being written to other parts of the response message 211.

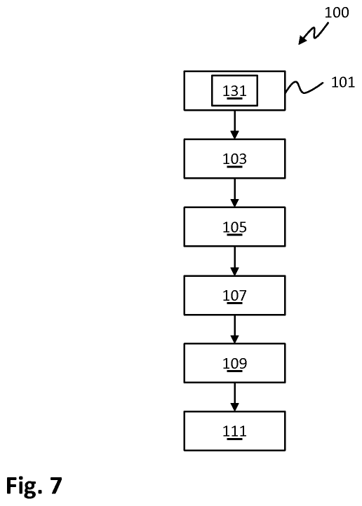

FIG. 7 shows a further flowchart of method 100 for operating a sensor system 200 according to a further embodiment.

The embodiment of FIG. 7 is based on the embodiment of FIG. 3 and comprises all the method steps described therein.

In the embodiment shown, the receiving step 101 further comprises a sampling step 131. In the sampling step 131, the trigger message 211 is sampled at an oversampling rate by the serial communication interface unit 217.

According to an embodiment, in the first writing step 117, groups of data bits of the trigger message 211 are written to the input buffer 215 in each of the execution cycles 223. In the processing step 107, the data bits of a group of data bits of the trigger message 211 previously written to the input buffer 215 are processed together.

In the second writing step 119, the groups of processing results are written to the output buffer 221 in the execution cycles 223.

This invention has been described with respect to exemplary embodiments. It is understood that changes can be made and equivalents can be substituted to adapt these disclosures to different materials and situations, while remaining with the scope of the invention. The invention is thus not limited to the particular examples that are disclosed, but encompasses all the embodiments that fall within the scope of the claims.

TABLE 1
References

100 Method
101 Receiving step
103 Receipt time determining step
105 Transmission time determining step
107 Processing step
109 Message generating step
111 Transmitting step
113 First position determining step
115 Second position determining step
117 First writing step
119 Second writing step
121 Activating step
123 Triggering step
125 Further triggering step
127 Sensor information determining step
129 Information writing step
131 Sampling step
200 Sensor system
201 Controller
203 Sensor unit
205 Two-wire physics
207 First microcontroller unit
209 Second microcontroller unit
211 Trigger message
213 Response message
215 Input buffer
217 Serial communication interface unit
219 Further serial communication
interface unit
221 Output buffer
223 Execution cycle
223-1 First execution cycle
223-2 Second execution cycle
223-3 Third execution cycle
223-4 Fourth execution cycle
223-5 Fifth execution cycle
223-6 Sixth execution cycle
223-7 Seventh execution cycle
223-8 Eighth execution cycle
223-9 Ninth execution cycle
223-10 Tenth execution cycle
223-11 Eleventh execution cycle
223-12 Twelfth execution cycle

TABLE 2
References (cont.)

223-13 Thirteenth execution cycle
225 Timer unit
227 Sensor element
229 Data output channel
231 Start section
233 Data Section
235 Transmission module
237 End section
241 First characteristic
243 Second characteristic
245 High level
245-1 First high level
245-2 Second high level
245-3 Third high level
247 Low level
249 CPU element
251 Data input channel
253 Clock channel
255 Chip select channel
257 Clock generator
259 Further processing component
263 Checksum section
265 Trigger section
267 Communication section
269 Last Characteristic
271 Transmission wire
273 Rising edge
DT1 First predefined delay period
DT2 Second predefined delay period
DT3 Third predefined delay period
DT4 Fourth predefined delay period
DT5 Fifth predefined delay period
DT6 Sixth predefined delay period
DT_rec Receiving time period
DT_dat Measuring period
T_dat Measuring time
T_send Transmitting time
T_rec Receiving time
T_act Activating time
T_samp Sampling time
t Time
P1 First positioning
P2 Second positioning

1. A method for operating a sensor system having at least one controller and one sensor unit,
wherein the controller and the sensor unit are connected to each other via a two-wire physics,
wherein data communication between the controller and the sensor unit is implemented via the two-wire physics,
wherein the controller comprises a first microcontroller unit and the sensor unit comprises a second microcontroller unit for carrying out the data communication; and
wherein the method further comprises:
receiving a trigger message sent by the controller via the two-wire physics with the aid of the sensor unit in a receiving step;
determining a receipt time of the receipt of the trigger message via the second microcontroller unit of the sensor unit in a receipt time determining step;
determining a transmission time for transmitting a response message from the sensor unit to the controller based on the receipt time with the aid of the second microcontroller unit of the sensor unit in an transmission time determining step, wherein the transmission time is temporally later than the receipt time by a first predefined delay period;
processing the trigger message with the aid of the second microcontroller unit of the sensor unit in a processing step;
generating the response message with the aid of the second microcontroller unit of the sensor unit in a message generating step; and
transmitting the response message from the sensor unit to the controller at the transmission time with the aid of the sensor unit in a transmitting step.

2. The method according to claim 1, wherein the receipt time determining step comprises:
determining a first temporal positioning of the trigger message in an input buffer of a serial communication interface unit of the first microcontroller unit via the second microcontroller unit in a first positioning determining step,
wherein the first temporal positioning of the trigger message in the input buffer corresponds to the receipt time of the trigger message, and wherein the transmission time determining step comprises:
determining a second temporal positioning of the response message in an output buffer of the serial communication interface unit of the second microcontroller unit via the second microcontroller unit in a second positioning determining step,
wherein the second temporal positioning is temporally distanced from the first temporal positioning by a second predefined delay period, and
wherein, based on the second positioning of the response message in the output buffer of the serial communication interface unit, the transmission time is determined.

3. The method according to claim 2, wherein the receiving step comprises:
writing the received trigger message to the input buffer of the serial communication interface unit of the second microcontroller unit in a first writing step; and
wherein the message generating step comprises:
writing the response message to the output buffer of the serial communication interface unit in the second temporal position determined in the second position determining step in a second writing step.

4. The method according to claim 3, wherein:
the first writing step, the second writing step, and the processing step are carried out in execution cycles, and
wherein the second predefined delay period comprises a predefined number of execution cycles.

5. The method according to claim 1, further comprising:
activating a timer unit of the sensor unit at an activation time to trigger the transmission of the response message at the transmission time via the second microcontroller unit of the sensor unit in an activating step,
wherein the activation time is temporally distanced from the transmission time by a third predefined delay period.

6. The method according to claim 5, wherein:
the timer unit in the activating step at the activation time further triggers a sensor element of the sensor unit to measure sensor data at a measurement time, and
wherein the activation time is temporally distanced from the measurement time by a fourth predefined delay period.

7. The method according to claim 5, wherein:
a data output channel of the serial communication interface unit is connected to an input port of the timer unit, and
wherein the timer unit is activated by the response message placed on the data output channel of the serial communication interface unit by the output buffer.

8. The method according to claim 5, wherein the activation time is temporally distanced from the second temporal positioning of the response message in the output buffer by a fifth predefined delay period.

9. The method according to claim 6, wherein the measurement time is temporally distanced from the receipt time by a sixth predefined delay period.

10. The method according to claim 9, wherein:
the first predefined delay period between the receipt time and the transmission time is calculated as a sum of the second predefined delay period between the first positioning of a first characteristic in the input buffer and the second positioning of a second characteristic in the output buffer and the fifth predefined delay period between the second positioning of the second characteristic in the output buffer and the activation time, and the third predefined delay period between the activation time and the transmission time, and/or
wherein the first predefined delay period and/or the second predefined delay period and/or the third predefined delay period and/or the fourth predefined delay period and/or the fifth predefined delay period and/or the sixth predefined delay period are pre-stored in the second microcontroller unit of the sensor unit.

11. The method according to claim 9, wherein the sixth predefined delay period between the receipt time and the measurement time is defined as a sum of the second predefined delay period between the first positioning of the first characteristic in the input buffer and the second positioning of the second characteristic in the output buffer and the fifth predefined delay period between the second positioning of the second characteristic in the output buffer and the activation time, and the fourth predefined delay period between the activation time and the measurement time.

12. The method according to claim 4, further comprising:
triggering a transmission module of the sensor unit to transmit the response message at the transmission time via the activated timer unit in a triggering step, wherein the transmission module is connected to and configured with the two-wire physics and configured to transmit the response message via the two-wire physics; and/or
triggering an acquisition of sensor data from the sensor element of the sensor unit via the activated timer unit at the measurement time in a further triggering step.

13. The method according to claim 12, wherein the processing step comprises:
determining sensor information based on the sensor data of the sensor element via the second microcontroller unit of the sensor unit in a sensor information determining step; and
wherein the second writing step comprises:
writing the sensor information into a data section of the response message in the output buffer of the serial communication interface unit via the second microcontroller unit of the sensor unit in an information writing step.

14. The method according to claim 13, wherein the data section is arranged in an end section of the response message.

15. The method according to claim 1, wherein:
the first writing step, the second writing step and the processing step are carried out in execution cycles,
wherein in the execution cycles the first writing step, the second writing step and the processing step are carried out simultaneously, and
wherein, during the simultaneous execution in the first writing step, in the second writing step and in the processing step, different parts of the trigger message and/or response message are taken into account in each case.

16. The method according to claim 1, wherein:
in the execution cycles in the first writing step, groups of data bits of the trigger message are written into the input buffer,
wherein in the processing step the data bits of a group of the trigger message written into the input buffer are processed together, and
wherein in the second writing step in the execution cycles, groups of processing results are written into the output buffer.

17. The method according to claim 1, wherein:
the trigger message and the response message are each configured as a telegram with at least one start section and the at least one data section, and
wherein the start section comprises a plurality of level changes and defines a start of the respective telegram.

18. The method according to claim 2, wherein:
the first temporal positioning of the trigger message in the input buffer is determined based on a temporal positioning of a first characteristic of the trigger message in the input buffer, and
wherein the second temporal positioning of the response message in the output buffer is determined based on a temporal positioning of a second characteristic of the response message in the output buffer corresponding to the first characteristic of the trigger message; and/or
wherein the first characteristic and/or the second characteristic is defined as a predefined sequence of high levels and/or low levels; and/or
wherein the first characteristic in the trigger message and the second characteristic in the response message each define a start-of-frame section; and/or
wherein the receiving step comprises:
sampling the trigger message at an oversampling rate by the serial communication interface unit of the second microcontroller unit in a sampling step, and/or
wherein majority decisions are carried out during oversampling by the serial communication interface unit via the second microcontroller unit, and/or
wherein the determined receipt time of the trigger message is defined by a sampling time of the sampling of the first characteristic of the trigger message via the serial communication interface unit, and/or
wherein the sampling step is carried out in the execution cycles, and wherein a length of the start section of the trigger message and/or a length of the start section of the response message corresponds to at least a maximum number of scans carried out per execution cycle.

19. The method according to claim 2, wherein:
a section positioned temporally before the response message in the output buffer of the serial communication interface unit is filled with zero bits; and/or
wherein bit boundaries are generated in the trigger message and/or the response message by a toggle method; and/or
wherein the serial communication interface unit is configured as an SPI interface unit; and/or
wherein the serial communication interface unit is operated as a serial/parallel converter; and/or
wherein the processing step is carried out by a CPU element of the second microcontroller unit, and wherein the CPU element comprises an interrupt request IRQ; and/or
wherein the frame of sensor information transmitted in the response message from the sensor unit to the controller is decoded and/or processed coherently via the first microcontroller unit of the controller; and/or
wherein the first microcontroller unit of the controller comprises a further serial communication interface unit, and wherein the further serial communication interface unit of the first microcontroller unit of the controller and the serial communication interface unit of the second microcontroller unit of the sensor unit are each operated in a controller mode; and/or
wherein the first predefined delay period is larger than or equal to a receipt period of the receipt of the trigger message via the sensor unit, wherein the receipt time period is defined as a time period between the receipt of the first characteristic of the trigger message and the receipt of a last characteristic of the trigger message; and/or
wherein the data communication between the controller and the sensor unit takes place in a half-duplex mode; and/or
wherein an energy transmission between the controller and the sensor unit is achieved via the two-wire physics in addition to data communication; and/or
wherein the serial communication interface unit of the sensor unit and/or the further serial communication interface unit are operated with an unassigned clock channel and/or an unassigned chip select channel.

20. A sensor system having at least one controller and a sensor unit configured to carry out a method according to claim 1, wherein:
the controller and the sensor unit are connected to each other via a two-wire physics,
wherein data communication between the controller is realized via the two-wire physics, and
wherein the controller comprising a first microcontroller unit and the sensor unit comprising a second microcontroller unit for carrying out the data communication; and/or
wherein the sensor unit comprises a timer unit, a sensor element and a transmission module,
wherein the second microcontroller unit of the sensor unit comprises a serial communication interface unit,
wherein a data output channel of the serial communication interface unit is connected to the transmission module and the timer unit,
wherein the timer unit is connected to the sensor element and the transmission module, and
wherein the transmission module is connected to the two-wire physics; and/or
wherein the sensor element is configured as a sensor element from the following list: position sensor element, temperature sensor element, vibration sensor element, acceleration sensor element.
